(19) United States
(12) Patent Application Publication
(10) Pub. No.: US 2013/0001116 A1
(43) Pub. Date: Jan. 3, 2013

(54) NAIL BELT HAVING MATING MEMBER AND CORRESPONDING MATING MEMBER AT BOTH ENDS RESPECTIVELY

(76) Inventors: Sheng-Huei Lin, (US); Chan-Wei Lin, (US)

(21) Appl. No.: 13/398,835

(22) Filed: Feb. 16, 2012

(30) Foreign Application Priority Data
Jun. 28, 2011 (TW) 100211731

(51) Int. Cl. B65D 85/24; B25C 1/00

(52) U.S. Cl. 206/347

(57) ABSTRACT

A nail belt is provided with a main body; teeth along either side of the main body; nail sockets depending from one surface of the main body; a mating member at one end of the main body and including two hollow cylinders each having two opposite latches on a circumferential surface; and a corresponding mating member at the other end of the main body and including two holes, two sets of two opposite flanges wherein the flanges of each set are formed on mouth of each hole, and a rectangular recess on the other surface of the main body and communicating with the holes. The cylinders of the mating member of a first nail belt can be inserted into the holes of the corresponding mating member of a second nail belt until the flanges are urged by the latches and the mating member is complementarily seated in the recess.

### BACKGROUND OF THE INVENTION

1. Field of the Invention

The invention relates to nail belts and more particularly to a nail belt having a mating member at one end and a corresponding mating member at the other end so that two nail belts can be joined together by fastening the mating member of a nail belt with the corresponding mating member of another nail belt.

2. Description of Related Art

A conventional nail belt 1 is shown in FIGS. 1 and 2 and comprises a plurality of equally spaced nail sockets 10, a mating member (e.g., a rectangular flat member having two holes as shown) 11 at one end, and a corresponding mating member (e.g., a rectangular flat member having two downward depending cylinders as shown) 12. Similar to fastening a button and a hole of a piece of clothing together, A person may press the cylinders of the corresponding mating member 12 on a nail belt 1 into the holes of the mating member 11 of another nail belt 1 to fasten the two nail belts 1 together.

However, the conventional nail belt 1 has a couple of disadvantages. For example, the button and hole fastening is not reliable, i.e., being subject to dislodgement. Further, as shown in FIG. 2, the top of the connected nail belts 1 are not flat, i.e., an irregularity (e.g., shoulder) existing at the joining portion of the two nail belts 1. This can jam a nailing operation of a nail gun when it encounters the irregularity. Thus, the need for improvement still exists.

### SUMMARY OF THE INVENTION

It is therefore one object of the invention to provide a nail belt comprising a flexible main body; a plurality of equally spaced rectangular projections formed along either side of the main body; a plurality of nail sockets depending from one surface of the main body; a mating member at one end of the main body and including a plurality of spaced, hollow cylinders each having two opposite latches on a circumferential surface; and a corresponding mating member at the other end of the main body and including a plurality of spaced holes, a plurality of sets of two opposite, curved flanges wherein the flanges of each set are formed on mouth of each hole, and a rectangular recess formed on the other surface of the main body, the recess communicating with the holes and being distal the flanges, wherein the cylinders of the mating member of a first nail belt can be inserted into the holes of the corresponding mating member of a second nail belt until the flanges are urged by the latches and the mating member is complementarily seated in the recess.

The above and other objects, features and advantages of the invention will become apparent from the following detailed description taken with the accompanying drawings.

### BRIEF DESCRIPTION OF THE DRAWINGS

FIG. 1 is a perspective view of a conventional nail belt;

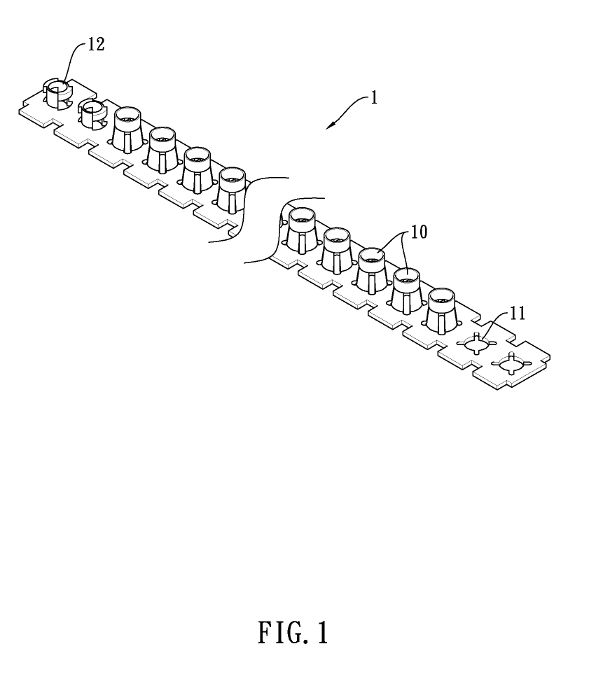

FIG. 2 is a longitudinal sectional view of the two conventional nail belts connected together by fastening one end of a nail belt and the other end of another nail belt together;

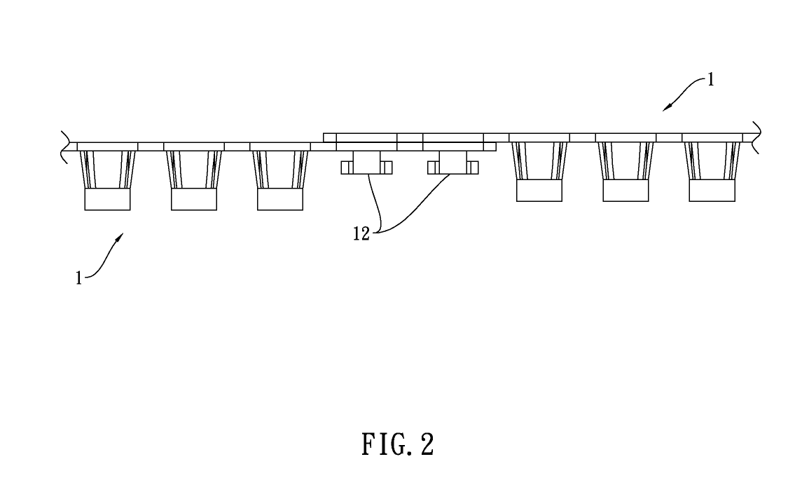

FIG. 3 is a perspective view of a nail belt according to a first preferred embodiment of the invention viewed from above;

FIG. 4 is another perspective of the nail belt of FIG. 3 viewed from below;

FIG. 5 is a side elevation in part of longitudinal section of the left portion of FIG. 3 and further being viewed upside down;

FIG. 6 is a side elevation in part of longitudinal section of the right portion of FIG. 3 and further being viewed upside down;

FIG. 7 is a side elevation in part of longitudinal section showing two nail belts being connected together to form a longer nail belt by fastening the mating member of one nail belt and the corresponding mating member of the other nail belt together;

FIG. 8 is a perspective view showing two connected nail belts loaded with nails to be ready to use;

FIG. 9 is a perspective view of a nail belt according to a second preferred embodiment of the invention;

FIG. 10 is a side elevation of the FIG. 9 and further being viewed with 180-degree turning;

FIG. 11 is a side elevation showing two nail belts of FIG. 9 connected together end by end to form a longer nail belt by fastening the mating member of one nail belt and the corresponding mating member of the other nail belt together;

FIG. 12 is a perspective view showing two connected nail belts of FIG. 9 loaded with nails to be ready to use;

FIG. 13 is a perspective view of a nail belt according to a third preferred embodiment of the invention;

FIG. 14 is a perspective view showing two nail belts of FIG. 13 to be connected together;

FIG. 15 is a perspective view of a nail belt according to a fourth preferred embodiment of the invention;

FIG. 16 is a side elevation of FIG. 15 and further being viewed with 180-degree turning;

FIG. 17 is a side elevation showing two nail belts of FIG. 15 connected together end by end to form a longer nail belt by fastening the mating member of one nail belt and the corresponding mating member of the other nail belt together; and

FIG. 18 is a perspective view showing two connected nail belts of FIG. 15 loaded with nails to be ready to use.

### DETAILED DESCRIPTION OF THE INVENTION

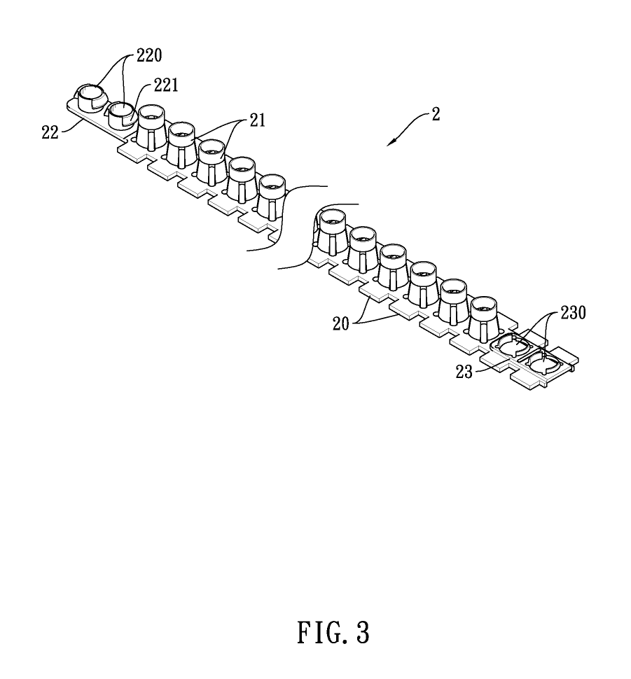

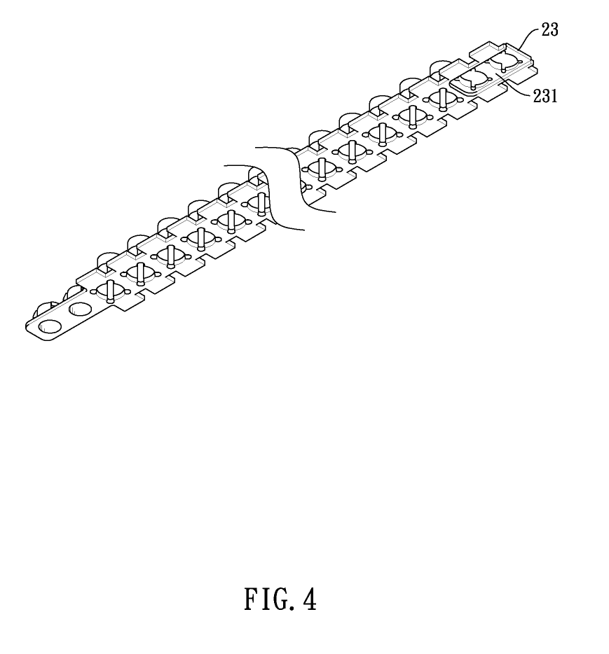

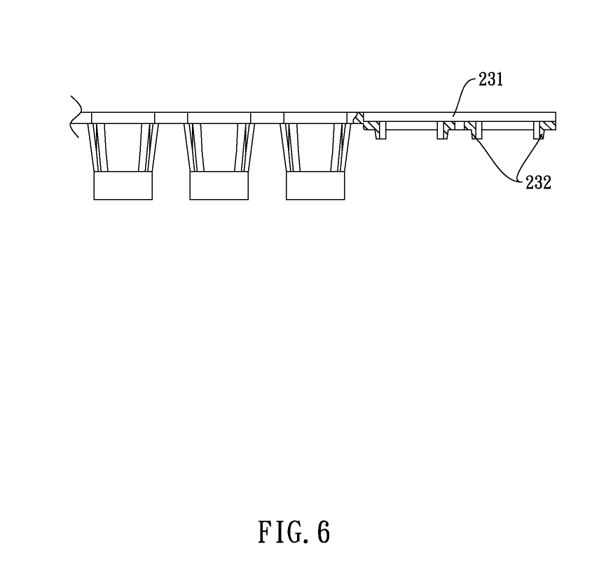

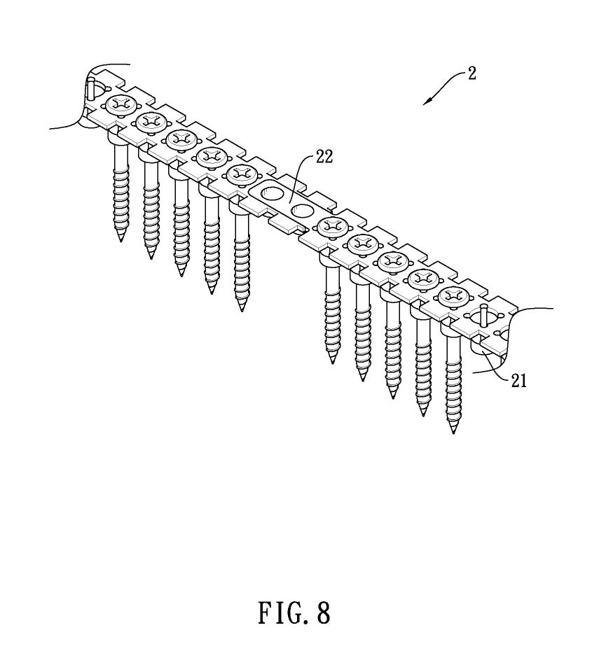

Referring to FIGS. 3 to 8, a nail belt in accordance with a first preferred embodiment of the invention comprises the following components as discussed in detail below.

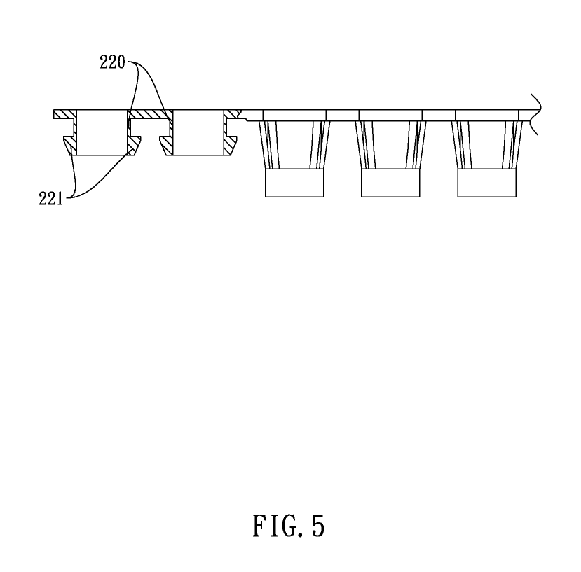

An elongated, plate shaped main body 2 is formed of flexible plastic such as PE (polyethylene). A series of equally spaced rectangular projections (e.g., teeth) 20 are formed along either side of the main body 2. A plurality of nail sockets 21 for nail loading each are depending downward from one surface of the main body 2. The nail socket 21 is substantially cylindrical but slightly tapered toward bottom (i.e., truncated conic) (see FIG. 5).

One end of the main body 2 is provided with a mating member 22 and the other end thereof is provided with a corresponding mating member 23. The mating member 22 comprises two spaced short, hollow, flexible cylinders 220 each have two opposite latches 221 on a circumferential surface. The latches 221 are on the opening of the cylinder 220 distal the other surface of the main body 2. The corresponding mating member 23 comprises two spaced, flexible holes 230, and two sets of two opposite, curved flanges 232 in which the two flanges 232 of each set are provided on the mouth of each hole 230, and a rectangular recess 231 on the other surface of the main body 2, communicating with the holes 230, and being distal the flanges 232.

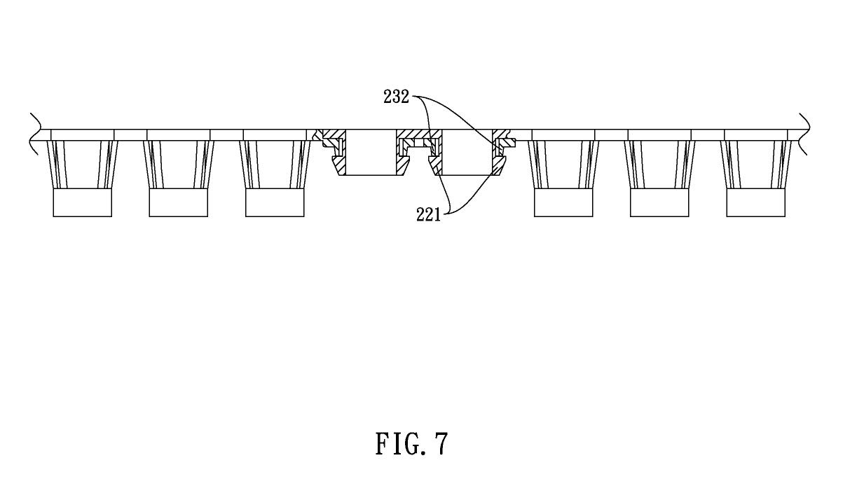

In a joining process, the flexible cylinders 220 of the mating member 22 of a nail belt can be inserted into the flexible holes 230 of the corresponding mating member 23 of another nail belt until the flanges 232 are urged by the latches 221 for fastening and the mating member 22 is complementarily seated in the recess 231 (see FIG. 7). It is shown that a flat surface is formed on the other surface of the main body 2.

It is envisaged by the invention that the fastening of two nail belts by performing above joining process is durable and reliable. It is noted that more than two nail belts can be joined together to form a longer one by performing the joining process repeatedly. Moreover, a nailing operation can be facilitated because the projections 20 do not interfere with a nail gun.

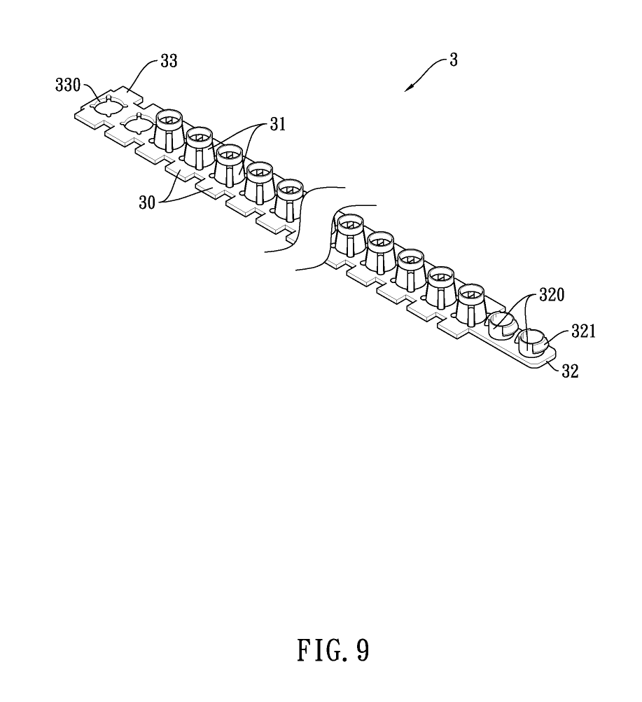

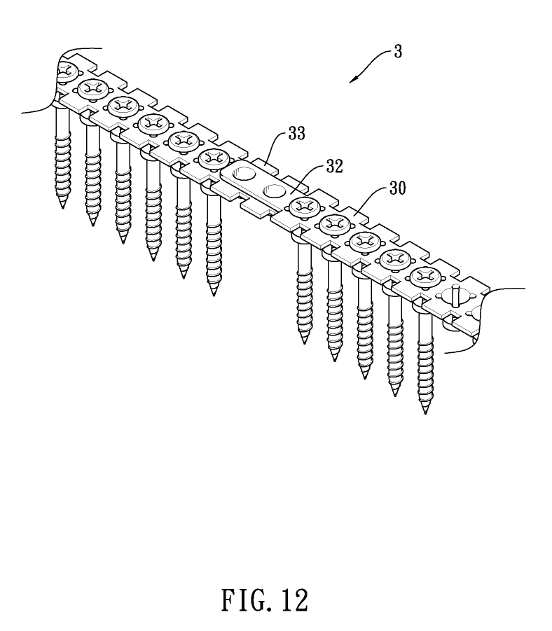

Referring to FIGS. 9 to 12, a nail belt in accordance with a second preferred embodiment of the invention is shown. The characteristics of the second preferred embodiment are substantially the same as that of the first preferred embodiment except the following:

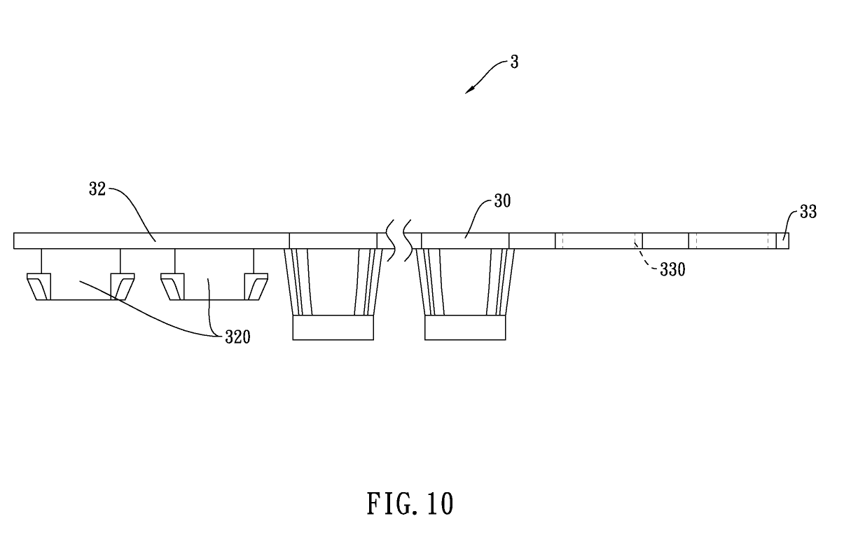

An elongated, plate shaped main body 3 is formed of flexible plastic such as PE. A series of equally spaced rectangular projections (e.g., teeth) 30 are formed along either side of the main body 3. A plurality of nail sockets 31 for nail loading each are depending downward from one surface of the main body 3. The nail socket 31 is substantially cylindrical but slightly tapered toward bottom (i.e., truncated conic) (see FIG. 10).

One end of the main body 2 is provided with a mating member 32 and the other end thereof is provided with a corresponding mating member 33. The mating member 32 has a width less than that of the main body 3 due to the elimination of the projections 30. The mating member 32 comprises two spaced short, hollow cylinders 320 each have two opposite latches 321 on a circumferential surface. The latches 321 are on the opening of the cylinder 320 distal the other surface of the main body 3. The corresponding mating member 33 comprises two spaced holes 330.

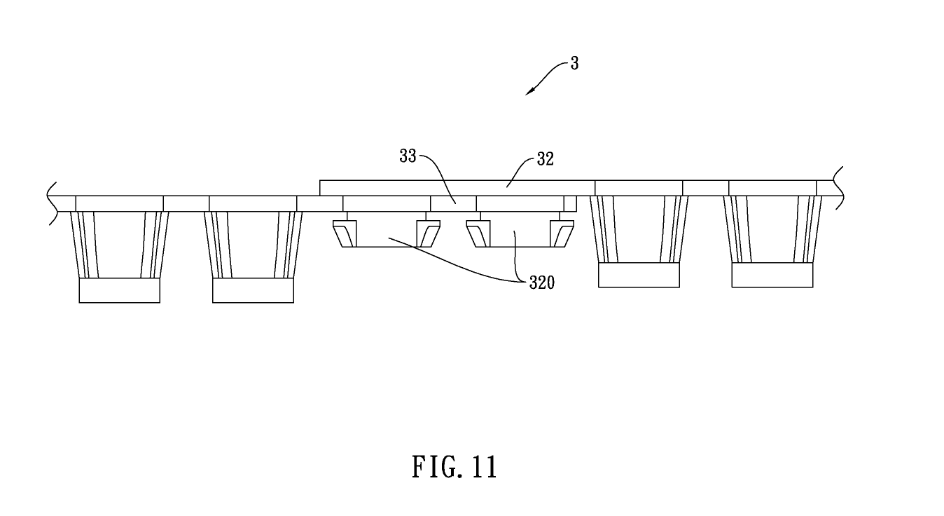

In a joining process, the flexible cylinders 320 of the mating member 32 of a nail belt can be inserted into the flexible holes 330 of the corresponding mating member 33 of another nail belt until the mating member 32 is laid on top of the corresponding mating member 33 for fastening (see FIG. 11). Also, the latches 321 are spaced from the corresponding mating member 33.

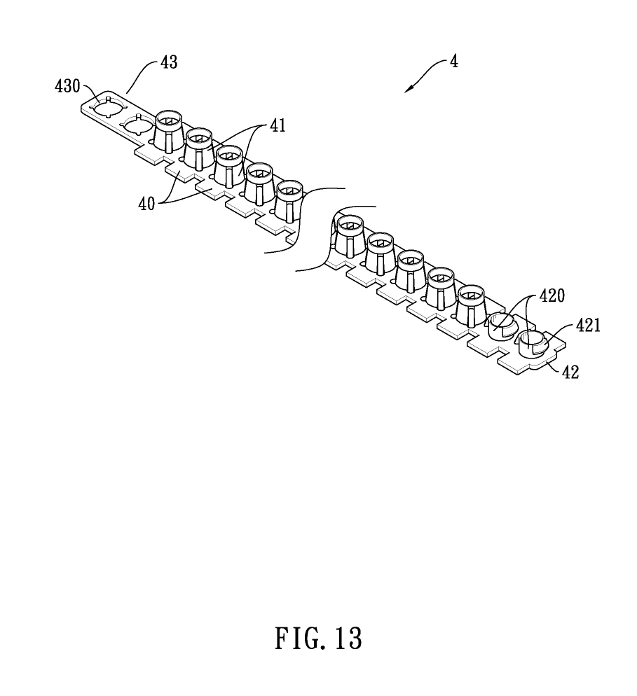

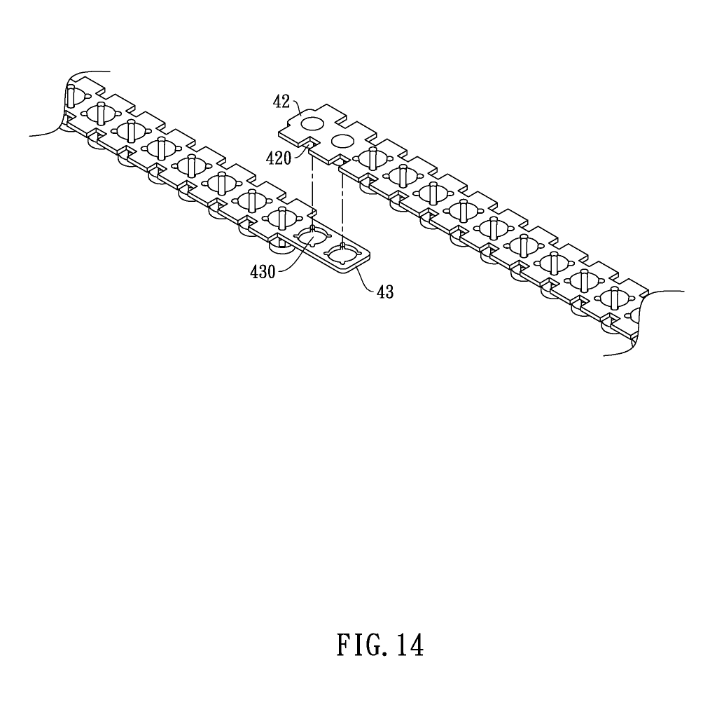

Referring to FIGS. 13 and 14, a nail belt in accordance with a third preferred embodiment of the invention is shown. The characteristics of the third preferred embodiment are substantially the same as that of the second preferred embodiment except the following:

An elongated, plate shaped main body 4 is formed of flexible plastic such as PE. A series of equally spaced rectangular projections (e.g., teeth) 40 are formed along either side of the main body 4. A plurality of nail sockets 41 for nail loading each are depending downward from one surface of the main body 4. The nail socket 41 is substantially cylindrical but slightly tapered toward top (i.e., truncated conic) (see FIG. 13).

One end of the main body 4 is provided with a mating member 42 and the other end thereof is provided with a corresponding mating member 43. The corresponding mating member 43 has a width less than that of the main body 4 due to the elimination of the projections 40. The mating member 42 comprises two spaced short, hollow cylinders 420 each have two opposite latches 421 on a circumferential surface. The latches 421 are on the opening of the cylinder 420 distal the other surface of the main body 4. The corresponding mating member 43 comprises two spaced holes 430.

In a joining process, the flexible cylinders 420 of the mating member 42 of a nail belt can be inserted into the flexible holes 430 of the corresponding mating member 43 of another nail belt until the mating member 42 is laid on top of the corresponding mating member 43 for fastening.

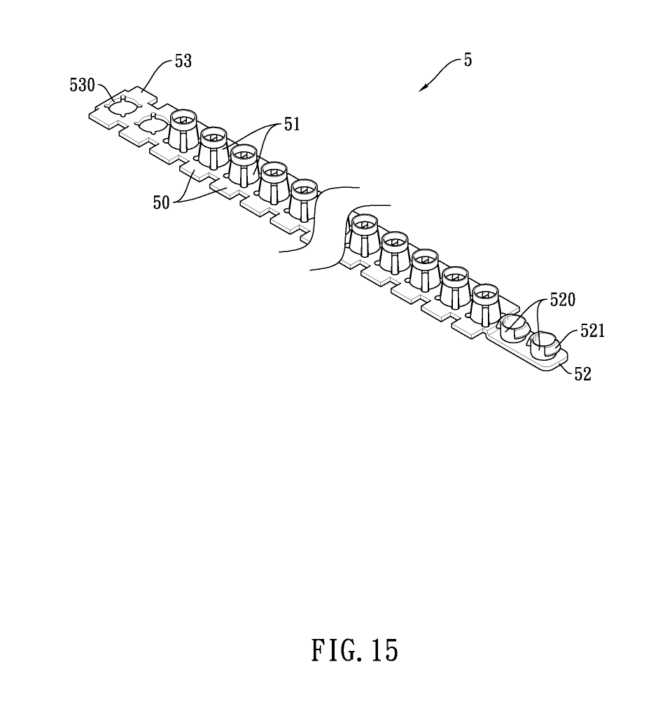

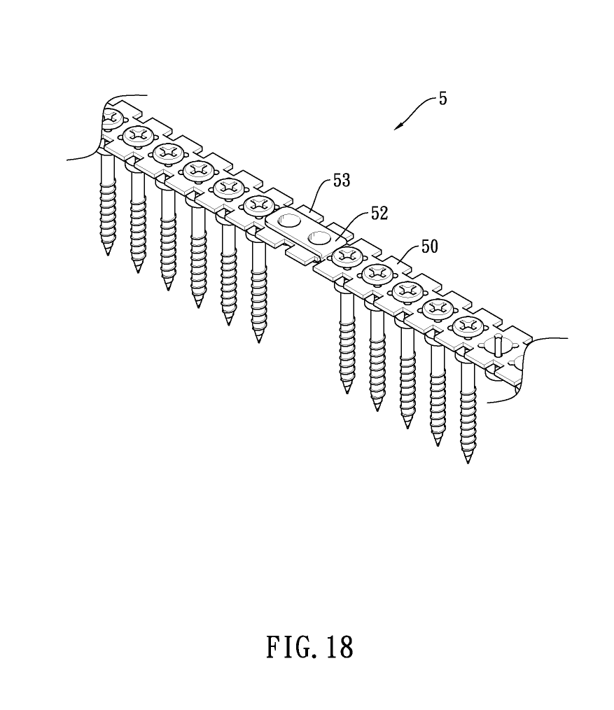

Referring to FIGS. 15 to 18, a nail belt in accordance with a fourth preferred embodiment of the invention is shown. The characteristics of the fourth preferred embodiment are substantially the same as that of the second preferred embodiment except the following:

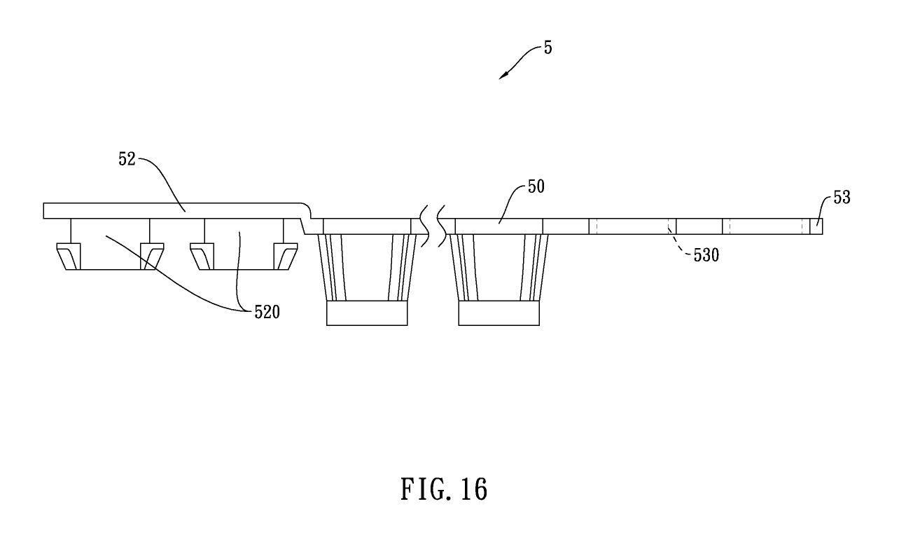

An elongated, plate shaped main body 5 is formed of flexible plastic such as PE. A series of equally spaced rectangular projections (e.g., teeth) 50 are formed along either side of the main body 5. A plurality of nail sockets 51 for nail loading each are depending downward from one surface of the main body 5. The nail socket 51 is substantially cylindrical but slightly tapered toward bottom (i.e., truncated conic) (see FIG. 16).

One end of the main body 5 is provided with a mating member 52 and the other end thereof is provided with a corresponding mating member 53. The mating member 52 has a width less than that of the main body 5 due to the elimination of the projections 50. The mating member 52 and the main body 5 are not at the same elevation due to an inclined surface interconnecting them. The mating member 52 comprises two spaced short, hollow cylinders 520 each have two opposite latches 521 on a circumferential surface. The latches 521 are on the opening of the cylinder 520 distal the other surface of the main body 5. The corresponding mating member 53 comprises two spaced holes 530.

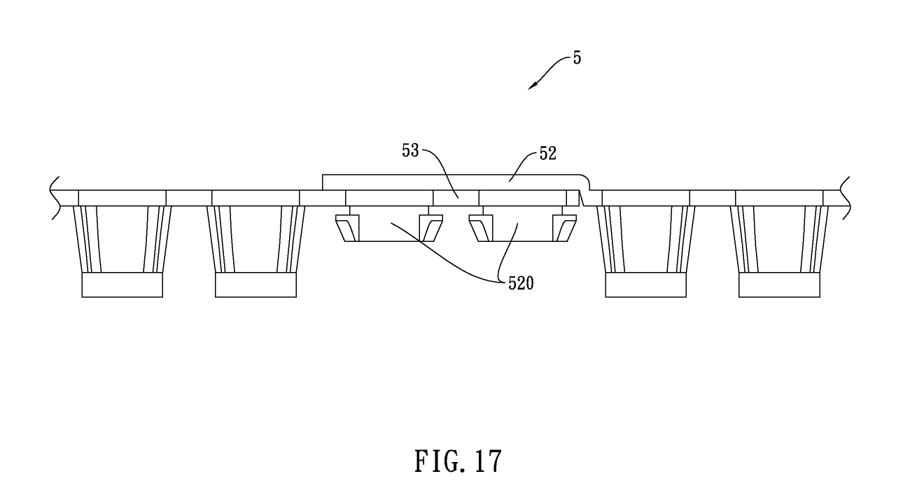

In a joining process, the flexible cylinders 520 of the mating member 52 of a nail belt can be inserted into the flexible holes 530 of the corresponding mating member 53 of another nail belt until the mating member 52 is laid on top of the corresponding mating member 53 for fastening (see FIG. 17). Also, the latches 521 are spaced from the corresponding mating member 53.

While the invention has been described in terms of preferred embodiments, those skilled in the art will recognize that the invention can be practiced with modifications within the spirit and scope of the appended claims.

What is claimed is:

1. A nail belt comprising:
a flexible main body;
a plurality of equally spaced rectangular projections formed along either side of the main body;
a plurality of nail sockets depending from one surface of the main body;
a mating member at one end of the main body and including a plurality of spaced, hollow cylinders each having two opposite latches on a circumferential surface; and
a corresponding mating member at the other end of the main body and including a plurality of spaced holes, a plurality of sets of two opposite, curved flanges wherein the flanges of each set are formed on mouth of each hole, and a rectangular recess formed on the other surface of the main body, the recess communicating with the holes and being distal the flanges,
wherein the cylinders of the mating member of a first nail belt can be inserted into the holes of the corresponding mating member of a second nail belt until the flanges are urged by the latches and the mating member is complementarily seated in the recess.

2. The nail belt of claim 1, wherein the main body is formed of PE (polyethylene).

3. The nail belt of claim 1, wherein the nail sockets are truncated conic.

4. The nail belt of claim 1, wherein the cylinders are flexible.

5. The nail belt of claim 1, wherein the holes are flexible.

6. A nail belt comprising:
a flexible main body;
a plurality of equally spaced rectangular projections formed along either side of the main body;
a plurality of nail sockets depending from one surface of the main body;
a rectangular mating member at one end of the main body and including a plurality of spaced, hollow cylinders each having two opposite latches on a circumferential surface wherein the mating member has a width less than that of the main body; and
a corresponding mating member at the other end of the main body and including a plurality of spaced holes,
wherein the cylinders of the mating member of a first nail belt can be inserted into the holes of the corresponding mating member of a second nail belt for fastening the mating member and the corresponding mating member together.

7. The nail belt of claim 6, wherein the main body is formed of PE (polyethylene).

8. The nail belt of claim 6, wherein the nail sockets are truncated conic.

9. The nail belt of claim 6, wherein the cylinders are flexible.

10. The nail belt of claim 6, wherein the holes are flexible.

11. A nail belt comprising:
a flexible main body;
a plurality of equally spaced rectangular projections formed along either side of the main body;
a plurality of nail sockets depending from one surface of the main body;
a mating member at one end of the main body and including a plurality of spaced, hollow cylinders each having two opposite latches on a circumferential surface; and
a corresponding mating member at the other end of the main body and including a plurality of spaced holes wherein the corresponding mating member has a width less than that of the main body,
wherein the cylinders of the mating member of a first nail belt can be inserted into the holes of the corresponding mating member of a second nail belt for fastening the mating member and the corresponding mating member together.

12. The nail belt of claim 11, wherein the main body is formed of PE (polyethylene).

13. The nail belt of claim 11, wherein the nail sockets are truncated conic.

14. The nail belt of claim 11, wherein the cylinders are flexible.

15. The nail belt of claim 11, wherein the holes are flexible.

16. The nail belt of claim 11, wherein the hollow cylinders each having two opposite latches on a circumferential surface wherein the mating member has a width less than that of the main body and the mating member and the main body are not at the same elevation.
